(19) United States
(12) Patent Application Publication
(10) Pub. No.: US 2007/0206905 A1
(43) Pub. Date: Sep. 6, 2007

(54) Fiber optics module mounted to the faceplate of a plug-in card

(75) Inventors: Stanley E. Swirhun, Jarfalla (SE); Marco Umberto Paolo Ghisoni, London (GB)

Correspondence Address: LAUBSCHER & LAUBSCHER, P.C., 1160 SPA ROAD, SUITE 2B, ANNAPOLIS, MD, 21403, US

(73) Assignee: Zarlink Semiconductor AB, Jarfalla (SE)

(21) Appl. No.: 11/364,994

(22) Filed: Mar. 1, 2006

(51) Int. Cl. G02B 6/36

(52) U.S. Cl. 385/88

(57) ABSTRACT

Disclosed is a fiber optics module for mounting to the faceplate of a plug-in card. The plug-in card for permitting optical communication with an electronic device comprises a rigid printed circuit board with an edge connector for making electrical connection with said electronic device; a faceplate attached to said printed circuit board for mounting to a bulkhead of the electronic device; a fiber optics module mounted on said faceplate for converting signals between electrical and optical formats, said fiber optics module having an optical connector for connection to a fiber optics cable; and a flexible film extending between said fiber optics module and a flexible film connector mounted on said printed circuit board, said flexible film having conductive tracks for carrying electrical signals between said fiber optics module and said printed circuit board.

### FIELD OF THE INVENTION

The present invention relates to the transmission of optical signals. More specifically, the present invention relates to a fiber optics module specifically designed for attachment to the faceplate of a plug-in card.

### BACKGROUND OF THE INVENTION

With the growth of computer networks, the demand for network devices is also rapidly increasing. A measure of performance of these network devices is the rate or speed at which the devices transfer data.

Today the vast majority of interconnections from faceplates of plug-in cards are achieved using high-performance electrical copper cabling. These connectors are based on parallel copper wires in a single cable, such as CX-4 connectors, to achieve a high data throughput. However, such high-speed copper connections are bulky and have thick, inflexible cables, which cause significant problems with cable management. Their bulk also means that they have poor surface edge density. In addition the length of such electrical interconnections is severely limited.

High-bandwidth optical interconnections are therefore required, since a greater volume of data can be transferred at higher speeds via fiber optics cables as compared to electrical wires. Today's optical solution is an optical dongle, which is externally attached to the electrical connector on the faceplate of the plug-in card. However, the dongle is bulky and as such protrudes from the front panel, interferes with cabling, and does not offer any improvement in regard to edge density.

Parallel Fiber Optics Modules (PFOMs) are an ideal solution since they are the equivalent to the parallel electrical connector.

To date PFOMs and fiber optics transceiver modules (e.g. SFP, XFP, XENPAK) have been bulky, in cages, employed recessed connectors, consumed lots of board space, have poor bandwidth edge density. They have also required large cut-outs in the faceplate which are non-optical for EMI. In addition they are costly multi-component implementations. One such example is POP4MSA PFOM from Zarlink Semiconductors.

The size of fiber optics modules is also important. The smaller the size of a fiber optics module, the less space taken on a printed circuit board (PCB) to which it couples and a greater number of fiber optics modules can be coupled onto a printed circuit. It is difficult to provide a parallel data connection for a fiber optics module in a small size.

### SUMMARY OF THE INVENTION

Disclosed is a Parallel Fiber Optics Module (PFOM) specifically designed for attachment to faceplates. Embodiments of the invention provide a compact, cost-effective high-bandwidth interconnection that is capable of extending across distances well in excess of those achievable with copper. In accordance with the invention, the PFOM is placed directly on the PCB, rather than an external attachment as provided by the dongle. The PFOM in accordance with this invention utilizes a MPO fiber ribbon.

Thus, according to one aspect, the invention provides a plug-in card for permitting optical communication with an electronic device, comprising a rigid printed circuit board with an edge connector for making electrical connection with said electronic device; a faceplate attached to said printed circuit board for mounting to a bulkhead of the electronic device; a fiber optics module mounted on said faceplate for converting signals between electrical and optical formats, said fiber optics module having an optical connector for connection to a fiber optics cable; and a flexible film extending between said fiber optics module and a flexible film connector mounted on said printed circuit board, said flexible film having conductive tracks for carrying electrical signals between said fiber optics module and said printed circuit board.

In one embodiment the fiber optics module comprises an MPO/MTP fiber ribbon connector. The fiber ribbon connector may comprise zero-insertion force connectors. The fiber ribbon connector may be vertically mounted relative to the printed circuit board.

In one embodiment, the fiber optics module comprises a heat sink permanently and intimately mounted to the faceplate. The heat sink is mounted to the faceplate via screw threads.

In one embodiment, the flexible film comprises a rigid base material to facilitate connection of the flexible film to the printed circuit board. The flexible film may be parallel to the printed circuit board. The flexible film may be soldered to the printed circuit board.

In one embodiment, the plug-in card further comprises drive/receive electronics mounted to the flexible film. In another embodiment, the plug-in card further comprises status LEDs mounted to the faceplate.

Optionally, the fiber optics module provides hot pluggability. Optionally, the fiber optics module is z-axis removable.

There are many advantages in using a PFOM in accordance with the teachings of this invention.

In comparison to copper electrical bulkheads, the Bulkhead PFOM in accordance with the teachings of this invention provides improved edge-density, reach-distance/data-rate and cable management advantages over copper. The MPO fiber ribbon connector is more space efficient that the CX-4 copper connector.

In comparison to the PFOM dongle—the CX-4 to PFOM/MPO externally connected interfaced module, the Bulkhead PFOM is advantageous because it doesn't protrude out, disconnect, interfere with cabling or require an external body of significant dimensions needed to allow heat sinking.

In comparison to the SNAP12 and POP4 PFOM, the Bulkhead PFOM uses less board space and is more cost effective, without comprising performance.

The Bulkhead PFOM in accordance with this invention is ideally suited to applications where the faceplate cut-out is not precisely mechanically located with respect to the PCB. The use of a flexible film allows it to tolerate such mechanical variations as are commonly encountered in manufacturing. The Bulkhead PFOM also uses the novel approach of using the faceplate itself as the heat-sink. This allows for a more compact solution. The Bulkhead PFOM is ‘z-pluggable’, and can be designed to enable the use of either a copper connector or Bulkhead PFOM with the same printed circuit board.

Other aspects and advantages of embodiments of the invention will be readily apparent to those ordinarily skilled in the art upon a review of the following description.

### BRIEF DESCRIPTION OF THE DRAWINGS

Embodiments of the invention will now be described in conjunction with the accompanying drawings, wherein:

FIG. 1 is a three-dimensional illustration of one possible design for a Parallel Fiber Optics Module (PFOM) in accordance with the teachings of this invention;

FIG. 2 is a front view of the PFOM of FIG. 1; and

FIG. 3 illustrates one possible attachment of the heat sink of the PFOM of FIG. 1 to a faceplate of a plug-in card.

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

### DETAILED DESCRIPTION OF THE PREFERRED EMBODIMENTS

This is fundamentally a novel concept repackage of the Parallel Fiber Optical Module (PFOM) concept, optimized for ultra-compact, space-sensitive, low-EMI, high-performance applications.

Fiber optics modules transduce optical signals received serially over optical fibers into electrical data signals. The electrical data signals can be coupled into and out of a fiber optics module through a serial data connection or a parallel data connection. A serial data connection can use few serial data input/output pin connections to serially transmit or receive electrical data signals. A parallel data connection uses parallel data input/output pin connections to transmit or receive electrical data signals in parallel. However for the same bit rate over data input/output pin connections, a parallel data connection can transmit data out of or receive data into a fiber optics module at a greater aggregate data rate.

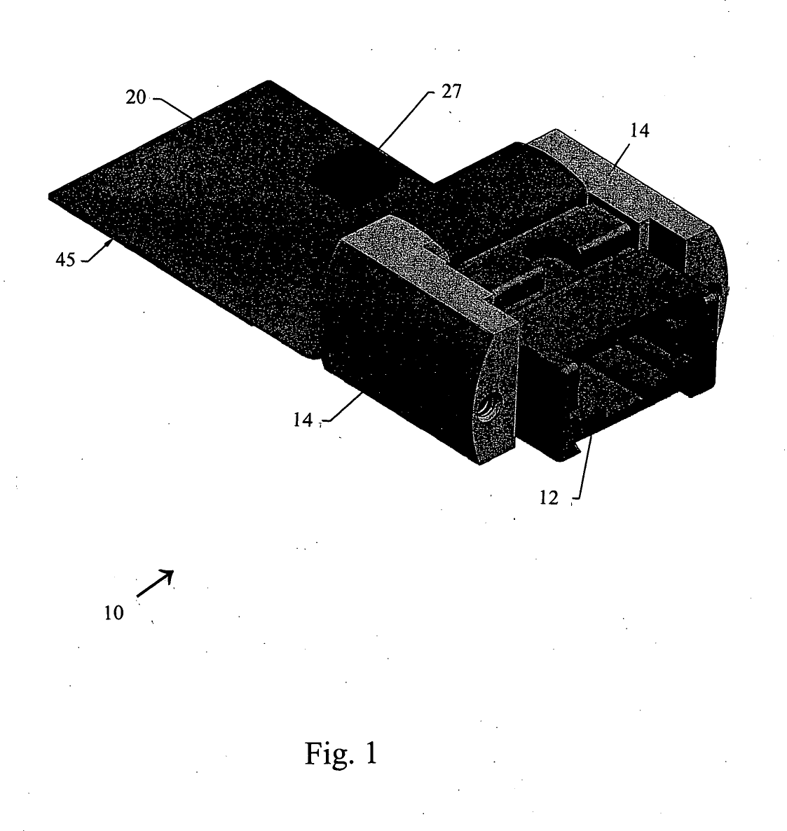

FIG. 1 is a three dimensional illustration of one possible design for such a Bulkhead PFOM 10 in accordance with the teachings of this invention. The Bulkhead PFOM 10 as with all PFOMs is a multi-channel media converter. The transmitter function converts electrical input signals to optical output signals, while the receiver function converts optical input signals to electrical output signals. This can be implemented either as discrete multi-channel transmitter and receiver modules or as a multi-channel transceiver module.

The PFOM of this invention retains high-bandwidth capability and performance of standard PFOMs.

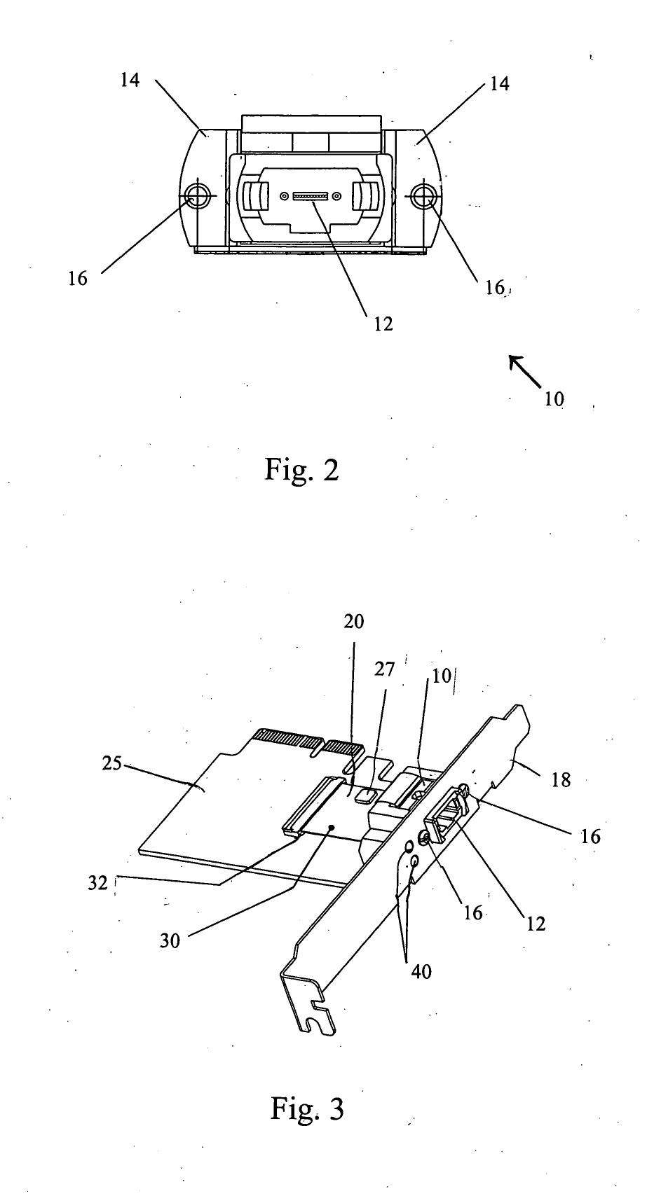

Referring to FIGS. 1 and 2, the optical connection 12 of the transducer as shown is via an industry-standard MPO/MTP fiber ribbon connector. The transmitter and receiver (not shown) are compatible with an industry-standard MTP*/MPO terminated parallel fiber optics interconnect. The optical receptacle of the Bulkhead PFOM allows fiber ribbon cable (not shown) to be attached and de-attached from the PFOM and provides the optical connectivity.

In an alternative embodiment, the PFOM could use MT rather than MPO optical fiber ribbon connector to reduce size.

FIG. 3 illustrates one possible attachment of the heat sink 14 of the PFOM 10 to a faceplate 18 of a plug-in card for permitting optical communication with an electronic device (not shown). The faceplate 18 is attached to the printed circuit board (PCB) 25 for mounting to a bulkhead (not shown) of the electronic device.

The reduced metallic heat sink 14 has screw threads 16 allowing it to be permanently attached to a faceplate 18 with which it will be in intimate contact. A typical attachment is shown schematically in FIG. 3. This attachment to a large volume of metal allows the size of the heat sink 14 to be reduced without comprising thermal performance. The optical receptacle protrudes through a cut-out in the faceplate 18. The nature of the cut-out and the heat sink 14 design means that the present solution is an improvement in terms of EMI/EMC over standard solutions. EMI issues, in particular, are of concern with any solutions that require cut-outs in the panel.

In another embodiment, the PFOM can be adapted to fix faceplate cutout from CX-4 or iPass electrical connector.

The electrical inputs and outputs are carried by a flexible film 20. A flexible film as its name implies is a flexible printed circuit board on which electric components can be mounted and which also provide the conductive tracks for carrying electrical signals between the fiber optics module and the printed circuit board. Flexible film printed circuit boards are available from any manufacturer, such as Juniper Circuits.

The flexible film 20 is connected to the front end of the PFOM 10 that contains relevant drive/receive electronics 27. In the example shown it is then bent by 90 degrees to be parallel to the PCB 25. The flexible film 20 also carries any additional electronics required by the PFOM 10, e.g. micro-controller, clock recovery circuitry etc. (not shown). Alternatively, the electronics may be directly located on the PCB.

The flexible film 20 is then attached to the PCB 25 using low-cost standard flex-ribbon connectors 30, for example zero-insertion force (ZIF) connectors.

The flexible film 20 by its very nature is flexible. This means that it is capable of compensating for manufacturing tolerances, in particular in the relative positions of the panel cut-out 18 and the PCB 25, without applying strain to the soldered electrical contact 32. This ability to act as a strain-relief mechanism allows low-cost manufacturing without the need for onerous, and costly, tolerances. Note that the flexible film 20 may, in sections, be rigid or semi-rigid via a rigid base material 45 to facilitate PCB connection.

The PFOM 10 could use flex-ribbon surface-mount connector that is vertically plugged, further reducing PCB area occupied. The flex-ribbon surface-mount connector 30 is less expensive and much easier to mount onto the PCBs. However it is contemplated that an alternative attachment solution to the PCB can be used. For example an XFP connecter can be used. Hence today's standard PFOMs (e.g. POP4 or SNAP 12) can be retrofitted and utilized in this manner.

In FIG. 3, green/red status LEDs 40 are shown on the faceplate 18. This can be driven directly from the Bulkhead PFOM 10. The electrical functionality of the Bulkhead PFOM 10 will be as for standard PFOMs, in addition serial digital interface can be made available to the end-user to allow control/status over a single interface. Note that the exact pin-out and customer interface will be various depending on exact market requirements, but will not alter the basic construction of the Bulkhead PFOM.

The Bulkhead PFOM 10 in accordance with this invention will have the same opto-electrical performance as a standard PFOM.

It is contemplated that the PFOM could be used with double-sided boards and stackable connectors.

In use, other communication channels are supported by other operating fiber optics modules. From a system point of view, it is desirable to be able to replace a parallel fiber optics transceiver module (for repair or upgrades for example) while the system is operational without having to power down the system. Thus the desirability to plug-in a new fiber optics module while the system is still hot, or in other words, to provide hot-pluggability.

The fiber optics transceiver module in accordance with this invention can provide hot pluggability. In a printed circuit board, hot-pluggability is provided on an edge of card by staggering signal traces from the power and ground traces. That is, when a printed circuit board is plugged into a hot system, power and ground are first supplied to the power and ground traces on the printed circuit board before the data signals are applied to signal traces and the circuitry therein.

In another embodiment, the PFOM can be z-axis removable with a tool.

The PFOM in accordance with the teachings of this invention can be utilized in a number of diverse applications. The PFOM could form part of a compact optical dongle, or could form part of a smart-cable solution where it is integrated part of cable.

The Bulkhead PFOM is ‘z-pluggable’, and can be designed to enable the use of either a copper connector or Bulkhead PFOM with the same printed circuit board. The PFOM could be entirely or part of a compact z-plug module.

Numerous modifications may be made without departing from the spirit and scope of the invention as defined in the appended claims.

1. A plug-in card for permitting optical communication with an electronic device, comprising:
a rigid printed circuit board with an edge connector for making electrical connection with said electronic device;
a faceplate attached to said printed circuit board for mounting to a bulkhead of the electronic device;
a fiber optics module mounted on said faceplate for converting signals between electrical and optical formats, said fiber optics module having an optical connector for connection to a fiber optics cable; and
a flexible film extending between said fiber optics module and a flexible film connector mounted on said printed circuit board, said flexible film having conductive tracks for carrying electrical signals between said fiber optics module and said printed circuit board.

2. The plug-in card of claim 1, wherein the fiber optics module comprises an MPO/MTP fiber ribbon connector.

3. The plug-in card of claim 2, wherein the fiber ribbon connector comprises zero-insertion force connectors.

4. The plug-in card of claim 2, wherein the fiber ribbon connector is vertically mounted relative to the printed circuit board.

5. The plug-in card of claim 1, wherein the fiber optics module comprises a heat sink permanently and intimately mounted to the faceplate.

6. The plug-in card of claim 5, wherein the heat sink is mounted to the faceplate via screw threads.

7. The plug-in card of claim 1, wherein the flexible film comprises a rigid base material to facilitate connection of the flexible film to the printed circuit board.

8. The plug-in card of claim 7, wherein the flexible film is parallel to the printed circuit board.

9. The plug-in card of claim 8, wherein the flexible film is soldered to the printed circuit board.

10. The plug-in card of claim 1, further comprising drive/receive electronics mounted to the flexible film.

11. The plug-in card of claim 1, further comprising status LEDs mounted to the faceplate.

12. The plug-in card of claim 1, wherein the fiber optics module provides hot pluggability.

13. The plug-in card of claim 1, wherein the fiber optics module is z-axis removable.
